(19) United States
(12) Patent Application Publication
(10) Pub. No.: US 2018/0306267 A1
(43) Pub. Date: Oct. 25, 2018

(54) MAGNETO-RHEOLOGICAL FLUID DAMPER

(71) Applicant: KYB Corporation, Tokyo (JP)

(72) Inventors: Yasuhiro YONEHARA, Kanagawa (JP); Atsushi OGAWA, Kanagawa (JP); Tatsuya NOMA, Gifu (JP)

(73) Assignee: KYB Corporation, Tokyo (JP)

(21) Appl. No.: 15/768,385

(22) PCT Filed: Sep. 9, 2016
(86) PCT No.: PCT/JP2016/076677

§ 371 Date: Apr. 13, 2018

(30) Foreign Application Priority Data
Nov. 19, 2015 (JP) 2015-226548

(51) Int. Cl. F16F 9/53; F16F 9/19

(52) U.S. Cl. CPC F16F 9/535; F16F 2228/066; F16F 2224/045; F16F 9/19

(57) ABSTRACT

A damper includes a cylinder into which magneto-rheological fluid is sealed, a first fluid chamber and a second fluid chamber, a throttle passage, an electromagnetic coil, and a spacer. The first fluid chamber and the second fluid chamber are partitioned by a piston core in the cylinder. The throttle passage is formed between an inner peripheral surface of the cylinder and an outer peripheral surface of the piston core. The throttle passage communicates between the first fluid chamber and the second fluid chamber. The throttle passage provides a resistance to a flow of the passing magneto-rheological fluid. The electromagnetic coil generates a magnetic field acting on the magneto-rheological fluid flowing through the throttle passage. The spacer is mounted to the piston core and is configured to adjust a length of the throttle passage.

### TECHNICAL FIELD

The present invention relates to a magneto-rheological fluid damper.

### BACKGROUND ART

JP2009-216210A discloses a damping force variable damper that includes a cylinder filled with magneto-rheological fluid, a piston where a flow passage to cause the magneto-rheological fluid to flow between a one-side liquid chamber and an other side liquid chamber is formed, and coils disposed in the piston. A magnetic field, which is generated by flowing a current into the coils, is applied to the magneto-rheological fluid passing through the flow passage to control a damping force. With the damping force variable damper of JP2009-216210A, when the magneto-rheological fluid passes through a void between an inner yoke and an outer yoke, energizing the coils causes a strong flow passage resistance by the magnetic field formed in the void, generating the high damping force.

### SUMMARY OF INVENTION

A magneto-rheological fluid is generally constituted of semifluid liquid produced by dispersing microparticles with ferromagnetism, such as iron powders, in liquid constituted of an oil, a grease, and a similar material. In such magneto-rheological fluid, a specific gravity of the iron is larger than a specific gravity of the liquid; therefore, the iron powders possibly precipitate in the liquid. Accordingly, it is considered that an increase in viscosity of the liquid of the magneto-rheological fluid reduces the precipitation of the iron powders. However, with the damping force variable damper described in JP2009-216210A, the magneto-rheological fluid flows through the narrow void between the inner yoke and the outer yoke. Accordingly, the increase in viscosity of the magneto-rheological fluid results in excessively large resistance given to the magneto-rheological fluid, making obtaining a desired damping force difficult.

An object of the present invention is to provide a magneto-rheological fluid damper that can obtain the desired damping force.

According to one aspect of the present invention, a magneto-rheological fluid damper that employs magneto-rheological fluid as working fluid, the magneto-rheological fluid changing apparent viscosity according to a strength of a magnetic field, the magneto-rheological fluid damper includes: a cylinder into which the magneto-rheological fluid is sealed; a piston made of a magnetic material, the piston being movably disposed in the cylinder; a first fluid chamber and a second fluid chamber partitioned by the piston in the cylinder; a throttle passage formed between an inner peripheral surface of the cylinder and an outer peripheral surface of the piston, the throttle passage communicating between the first fluid chamber and the second fluid chamber, the throttle passage providing a resistance to a flow of the passing magneto-rheological fluid; an electromagnetic coil disposed at the piston, the electromagnetic coil being configured to generate the magnetic field, the magnetic field acting on the magneto-rheological fluid flowing through the throttle passage; and the adjusting member mounted to the piston, the adjusting member being configured to adjust a length of the throttle passage.

### BRIEF DESCRIPTION OF DRAWINGS

FIG. 1 is a cross-sectional view of a magneto-rheological fluid damper in an axis direction according to a first embodiment of the present invention.

FIG. 2 is a cross-sectional view taken along an A-A in FIG. 1.

FIG. 3 is a cross-sectional view of a magneto-rheological fluid damper in an axis direction according to a second embodiment of the present invention.

FIG. 4 is a cross-sectional view taken along a B-B in FIG. 3.

FIG. 5 is a cross-sectional view of a magneto-rheological fluid damper in an axis direction according to a third embodiment of the present invention.

FIG. 6 is a cross-sectional view of a magneto-rheological fluid damper in an axis direction according to a modification of the present invention.

### DESCRIPTION OF EMBODIMENTS

The following describes embodiments of the present invention with reference to the drawings.

### First Embodiment

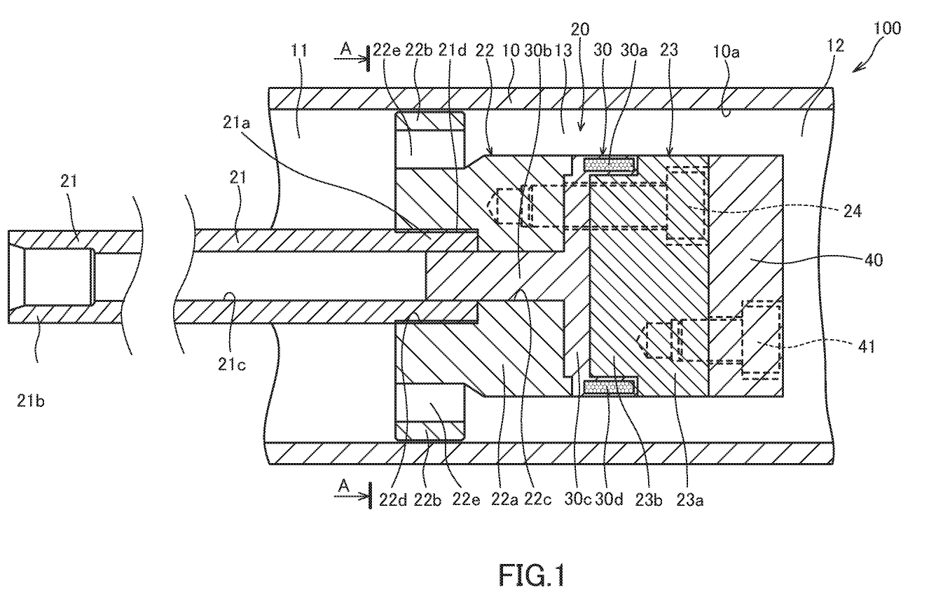

FIG. 1 is a cross-sectional view of a piston of a magneto-rheological fluid damper 100 (hereinafter simply referred to as a “damper 100”) in an axis direction. The damper 100 is, for example, disposed between a vehicle body and a wheel shaft in a vehicle such as an automobile to generate a damping force, which reduces vibrations of the vehicle body through extension and contraction.

The damper 100 includes a cylindrical cylinder 10, a piston core 20, a first fluid chamber 11 and a second fluid chamber 12, and a piston rod 21. Magneto-rheological fluid serving as working fluid is sealed in the cylinder 10. The piston core 20 serving as a piston is movably disposed in the cylinder 10. The piston core 20 partitions the first fluid chamber 11 and the second fluid chamber 12 in the cylinder 10. The piston rod 21 is coupled to the piston core 20 and extends to an outside of the cylinder 10.

The cylinder 10 is formed into a closed-bottomed cylindrical shape. The magneto-rheological fluid sealed in the cylinder 10 changes apparent viscosity by an action of a magnetic field. The magneto-rheological fluid is semifluid liquid produced by dispersing microparticles with ferromagnetism, such as an iron, in liquid with high viscosity constituted of an oil, a grease, and a similar material. The high viscosity of the embodiment specifically means viscosity of around 3 to 20 Pa·s at 25° C. and a shear velocity of 1 (1/s) and viscosity of around 0.1 to 1.0 Pa·s at 25° C. and the shear velocity of 500 (1/s). The viscosity of the magneto-rheological fluid changes according to a strength of the magnetic field acting on the magneto-rheological fluid. When the magneto-rheological fluid is free from the influence of the magnetic field, the magneto-rheological fluid returns to an original state.

The piston rod 21 is formed coaxially with the piston core 20. A one-end 21a of the piston rod 21 is secured to the piston core 20, and an other end 21b extends to the outside of the cylinder 10. The piston rod 21 is formed into a cylindrical shape whose one-end 21a and other end 21b are open. A pair of wirings (not illustrated) to supply an electromagnetic coil 30a, which will be described later, of the piston core 20 with a current are passed through a hollow portion 21c of the piston rod 21. A male screw 21d screwed with the piston core 20 is formed on an outer periphery near the one-end 21a of the piston rod 21. The piston core 20 and the piston rod 21 are coupled by screwing.

A gas chamber (not illustrated) into which gas is sealed is partitioned by a free piston (not illustrated) in the cylinder 10. The gas chamber compensates a volume changes in the cylinder 10 by advance and retract of the piston rod 21.

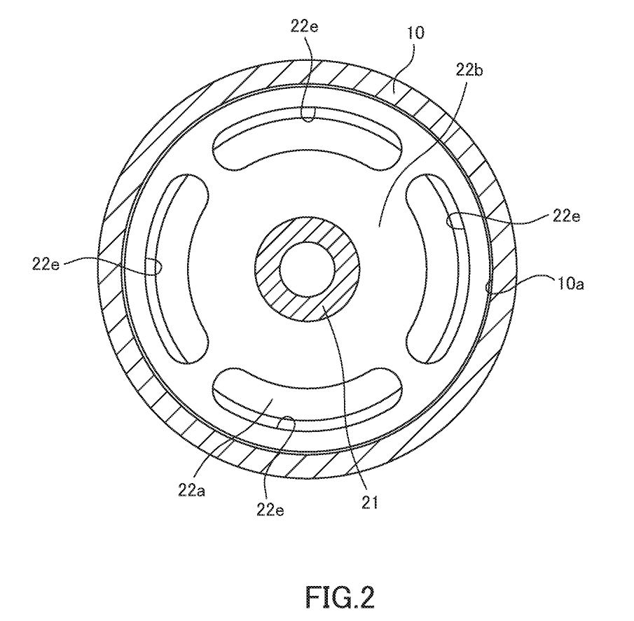

The following describes a specific configuration of the piston core 20 with reference to FIG. 1 and FIG. 2.

The piston core 20 includes a first core 22, a coil assembly 30, and a second core 23. The first core 22 is mounted to the one-end 21a of the piston rod 21. The electromagnetic coil 30a is disposed on an outer periphery of the coil assembly 30. The second core 23 sandwiches the coil assembly 30 with the first core 22. The first core 22, the second core 23, and the coil assembly 30 are tightened with a pair of bolts 24. The first core 22 and the second core 23 are made of a magnetic material.

The first core 22 includes a columnar-shaped main body 22a and a disk-shaped guiding portion 22b. The guiding portion 22b projects radially outside from the main body 22a and slides on an inner peripheral surface 10a of the cylinder 10.

The main body 22a of the first core 22 has a through-hole 22c that axially passes through a center. The through-hole 22c includes a female thread portion 22d screwed with a male screw 21d, which is formed on the one-end 21a of the piston rod 21.

The guiding portion 22b includes communication passages 22e that communicate between the first fluid chamber 11 and the second fluid chamber 12. As illustrated in FIG. 2, the plurality of communication passages 22e are formed into an arc shape.

The second core 23 includes a columnar-shaped main body 23a and a supporting portion 23b with a diameter smaller than that of the main body 23a. An outer shape of the main body 23a is formed to be identical to an outer shape of the main body 22a of the first core 22.

The coil assembly 30 is formed by molding a resin with the annular-shaped electromagnetic coil 30a inserted. The coil assembly 30 includes a column portion 30b fitted to the through-hole 22c on the first core 22, a coupling portion 30c sandwiched between the first core 22 and the second core 23, and a coil mold portion 30d that internally includes the electromagnetic coil 30a. An inner peripheral surface of the coil mold portion 30d fits to an outer peripheral surface of the supporting portion 23b of the second core 23. Thus, the supporting portion 23b of the second core 23 supports the coil assembly 30.

The damper 100 includes a throttle passage 13 and the electromagnetic coil 30a serving as a damping force generating element. The throttle passage 13 is formed between the inner peripheral surface 10a of the cylinder 10 and the outer peripheral surface of the piston core 20 to communicate between the first fluid chamber 11 and the second fluid chamber 12. The electromagnetic coil 30a is disposed at the piston core 20 to generate a magnetic field acting on the magneto-rheological fluid flowing the throttle passage 13.

The throttle passage 13 is annularly formed between the inner peripheral surface 10a of the cylinder 10 and the outer peripheral surface of the piston core 20, specifically, between the inner peripheral surface 10a of the cylinder 10 and the outer peripheral surfaces of the first core 22, the coil assembly 30, and the second core 23. A flow passage area of the throttle passage 13 is formed to be smaller than a sum of flow passage areas of the plurality of communication passages 22e, which are formed at the guiding portion 22b.

When the damper 100 extends and contracts and the magneto-rheological fluid moves between the first fluid chamber 11 and the second fluid chamber 12, the throttle passage 13 gives a resistance to the flow of the passing magneto-rheological fluid. Giving the resistance to the flow of the magneto-rheological fluid passing through the throttle passage 13 causes the damper 100 to generate the damping force.

The electromagnetic coil 30a forms the magnetic field by the current supplied from the outside. The strength of this magnetic field strengthens as the current supplied to the electromagnetic coil 30a increases. As described above, since the first core 22 and the second core 23 are formed by the magnetic material, these members constitute a magnetic path to guide magnetic flux generated around the electromagnetic coil 30a.

The following describes actions of the damper 100.

The extension and contraction of the damper 100 moves the piston core 20 inside the cylinder 10. When the piston core 20 moves with respect to the cylinder 10, the magneto-rheological fluid moves between the first fluid chamber 11 and the second fluid chamber 12 through the throttle passage 13 and the communication passages 22e.

At this time, giving the resistance to the magneto-rheological fluid passing through the throttle passage 13 by the throttle passage 13 causes the damper 100 to generate the damping force.

The damping force generated by the damper 100 is adjusted by changing an amount of energization to the electromagnetic coil 30a and changing the strength of the magnetic field acting on the magneto-rheological fluid flowing through the throttle passage 13. The apparent viscosity of the magneto-rheological fluid changes by the strength of the acting magnetic field. To describe specifically, the larger the current supplied to the electromagnetic coil 30a, the larger the strength of the magnetic field generated around the electromagnetic coil 30a. This increases the apparent viscosity of the magneto-rheological fluid flowing the throttle passage 13, thereby increasing the damping force generated by the damper 100.

Thus, with the damper 100, in addition to the damping force generated by the resistance of the throttle passage 13, changing the amount of energization to the electromagnetic coil 30a allows the adjustment of the damping force.

With the damper 100, because a flux ring is not disposed at the piston core 20, it is possible to increase the flow passage area of the throttle passage 13. Accordingly, even if the viscosity of the magneto-rheological fluid increases, the damper 100 can secure fluidity equivalent to the magneto-rheological fluid with low viscosity.

However, the expansion of the flow passage area of the throttle passage 13 reduces the resistance generated in the throttle passage 13 by the amount. This reduces the damping force. Accordingly, with this embodiment, a spacer 40 serving as an adjusting member is mounted to one end portion of the piston core 20. The following describes the spacer 40.

As illustrated in FIG. 1, the spacer 40 is a column-shaped member whose outer shape is formed to be approximately identical to an outer shape of the second core 23 (piston core 20). The spacer 40 is mounted on one end surface of the second core 23 on a side opposite to the coil assembly 30 with a bolt 41. Thus, mounting the spacer 40 can lengthen a length of the throttle passage 13. This allows increasing the resistance generated by the throttle passage 13 even if the flow passage area of the throttle passage 13 is expanded. Furthermore, the adjustment of the axial length of the spacer 40 allows adjusting the resistance generated by the throttle passage 13.

It should be noted that, the spacer 40 may be a ring shape or may be a cylindrical shape with closed bottom opening to the second core 23 side. This allows a weight reduction of the spacer 40. A material of the spacer 40 may be a magnetic or non-magnetic.

With the embodiment illustrated in FIG. 1, the spacer 40 and the second core 23 are mounted such that flat end surfaces mutually abut on. Instead of this, a convex portion may be disposed on one side and a concave portion may be disposed on the other side so as to fit these members. This configuration fits the spacer 40 and the piston core 20 to one another; therefore, axis centers of the spacer 40 and the piston core 20 are not displaced. This allows the throttle passage 13 to be configured as the annular-shaped flow passage with uniform degree of opening.

The above-described first embodiment provides the following effects.

With the damper 100, the throttle passage 13 is formed between the inner peripheral surface 10a of the cylinder 10 and the outer peripheral surface of the piston core 20. Additionally, the spacer 40 to allow the adjustment of the length of the throttle passage 13 is mounted to the piston core 20. Thus, appropriately adjusting the length of the spacer 40 according to the viscosity of the magneto-rheological fluid allows obtaining a desired damping force in the throttle passage 13. That is, adjusting the axial length of the spacer 40 allows changing the length of the throttle passage 13 and adjusting the damping force by the damper 100.

With the damper 100, since the throttle passage 13 is formed into the annular shape, this uniforms the flow of the magneto-rheological fluid flowing through the throttle passage 13. Accordingly, when the magneto-rheological fluid flows, because the uniform force acts on the piston core 20, it is possible to prevent a deviation of the piston core 20.

Furthermore, the piston core 20 includes the guiding portion 22b that slides on the inner peripheral surface 10a of the cylinder 10. This avoids the piston core 20 in motion inside the cylinder 10 to deviate inside the cylinder 10. Accordingly, the shape of the throttle passage 13 does not change. This allows always imparting the constant resistance to the flow of the magneto-rheological fluid.

The damper 100 can adjust the initial damping force by the spacer 40, ensuring uniformizing the piston core 20.

The higher viscosity of the magneto-rheological fluid fails to cause the magneto-rheological fluid to flow through the narrow flow passage due to a flow resistance by the viscosity. However, the damper 100 does not include the flux ring at the piston core 20; therefore, the flow passage area of the throttle passage 13 can be expanded. Accordingly, the high-viscosity magneto-rheological fluid is applicable to the damper 100. Thus, the use of the high-viscosity magneto-rheological fluid allows reducing a precipitation of iron powders into a bottom portion of the cylinder 10. This allows the stable damping force.

The viscosity of the magneto-rheological fluid increases under a low temperature environment or a similar environment. Accordingly, not limited the high-viscosity magneto-rheological fluid as described above, the use of the damper 100 under such situation allows the stable damping force.

### Second Embodiment

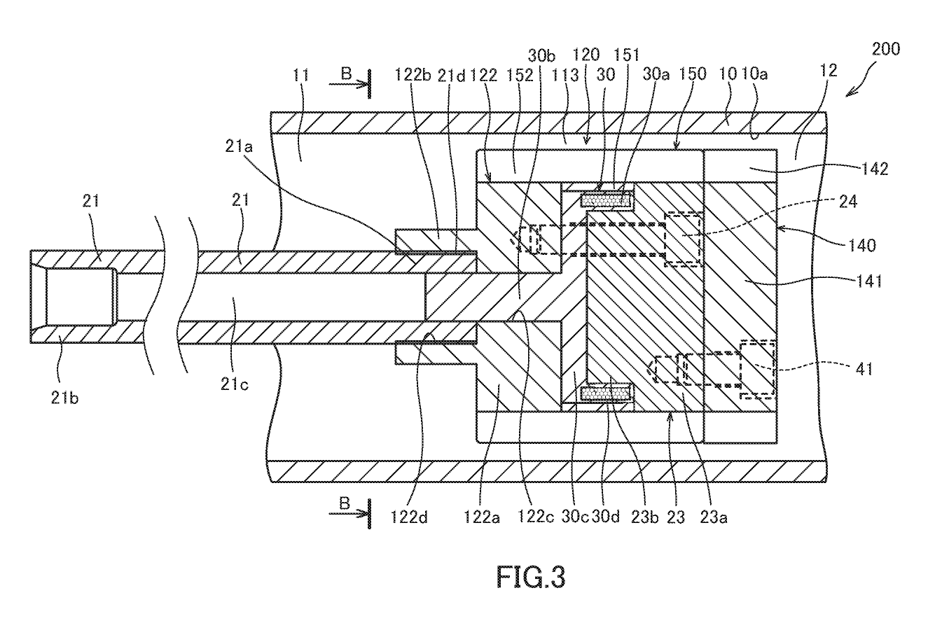

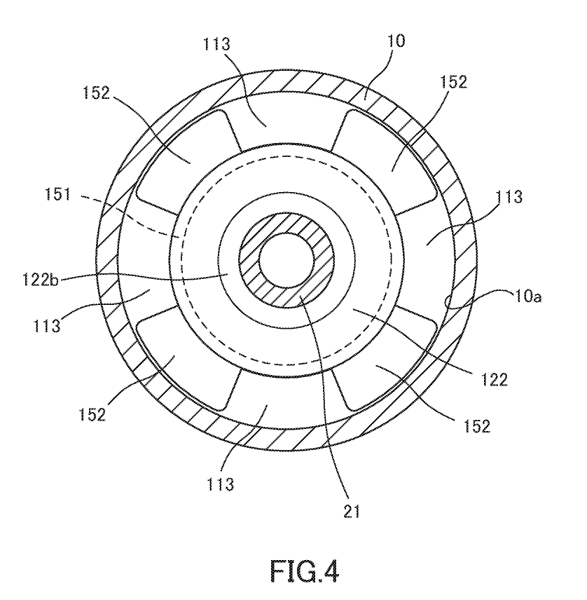

The following describes a damper 200 according to the second embodiment of the present invention with reference to FIG. 3 and FIG. 4. Hereinafter, the difference from the first embodiment described above will be mainly described. Like reference numerals designate identical configurations to the damper in the first embodiment, and therefore such configurations will not be further elaborated here.

While the damper 100 of the first embodiment has the configuration of disposing the guiding portion 22b at the first core 22, the damper 200 of the second embodiment differs in that a third core 150 is disposed at outer periphery portions of the first core 22, the coil assembly 30, and the second core 23.

As illustrated in FIG. 3, the damper 200 includes a piston core 120 movably disposed in the cylinder 10.

The piston core 120 includes a first core 122, the coil assembly 30, the second core 23, and the third core 150. The first core 122 is mounted to the one-end 21a of the piston rod 21. The electromagnetic coil 30a is disposed on the outer periphery of the coil assembly 30. The second core 23 sandwiches the coil assembly 30 with the first core 22. The third core 150 is disposed so as to contact outer peripheral surfaces of the first core 122, the coil assembly 30, and the second core 23. The first core 122 and the second core 23 are made of the magnetic material, and the third core 150 is made of a non-magnetic material.

The first core 122 includes a columnar-shaped main body 122a and a small-diameter portion 122b. The small-diameter portion 122b has a diameter smaller than that of the main body 122a and is formed at one end of the main body 122a.

The first core 122 has a through-hole 122c that axially passes through a center. The through-hole 122c includes a female thread portion 122d screwed with the male screw 21d, which is formed on the one-end 21a of the piston rod 21.

The third core 150 includes an annular-shaped main body 151 (see the dotted line part in FIG. 4) and guiding portions 152. The guiding portions 152 are mounted to the main body 151 to guide the piston core 120.

An outer shape of the main body 151 is formed to be identical to outer shapes of the main body 122a of the first core 122 and the main body 23a of the second core 23. An axial length of the main body 151 is formed to be equal to the axial length of the coil mold portion 30d of the coil assembly 30. The coil assembly 30 supports an inner peripheral of the main body 151. The main body 151 is axially sandwiched between the first core 122 and the second core 23. The first core 122, the second core 23, and the coil assembly 30 are tightened with the pair of bolts 24. This integrates the first core 122, the second core 23, the coil assembly 30, and the third core 150.

The guiding portions 152 are formed such that the axial length of the guiding portions 152 is equal to the total axial lengths of the first core 122, the second core 23, and the coil assembly 30 which are integrated. As illustrated in FIG. 4, a radial cross-sectional shape of the guiding portions 152 is formed into a fan shape such that outer peripheral surfaces of the guiding portions 152 can slide on the inner peripheral surface 10a of the cylinder 10. The four guiding portions 152 are disposed circumferentially at regular intervals. Throttle passages 113 to communicate between the first fluid chamber 11 and the second fluid chamber 12 are formed between the adjacent guiding portions 152.

A spacer 140 is mounted to one end portion of the piston core 120. A radial cross-sectional shape of the spacer 140 is formed to be identical to that of the piston core 120. Specifically, a main body 141 of the spacer 140 is formed into a columnar shape with an outer shape identical to those of the main body 122a of the first core 122 and the main body 23a of the second core 23. A guiding portion 142 with a cross-sectional shape identical to the guiding portion 152 of the third core 150 is disposed on an outer periphery of the main body 141 at a position matching a position of the guiding portion 152 in the circumferential direction. The throttle passage 113 is formed between the adjacent guiding portions 142 of the spacer 140.

The adjustment of the damping force by the damper 200 and the actions of the spacer 140 are similar to the first embodiment; therefore, the following omits the explanation.

The above-described second embodiment provides the following effects.

With the damper 200, the throttle passages 113 are formed between the inner peripheral surface 10a of the cylinder 10, the outer peripheral surfaces of the first core 122, the second core 23, and the main body 151 of the third core 150, and the adjacent guiding portion 152 of the third core 150. Additionally, the spacer 140 that allows the adjustment of the length of the throttle passage 113 is mounted to the piston core 120. This allows obtaining the desired damping force in the throttle passage 113. That is, adjusting the axial length of the spacer 140 allows changing the length of the throttle passage 113 and adjusting the damping force by the damper 200.

The third core 150 includes the guiding portion 152 that slides on the inner peripheral surface 10a of the cylinder 10. This ensures avoiding the piston core 120 in motion inside the cylinder 10 to deviate inside the cylinder 10. Forming the guiding portions 142 and the guiding portions 152 allows disposing the guides long with respect to the axis direction of the piston core 120, ensuring stably guiding the piston core 120.

### Third Embodiment

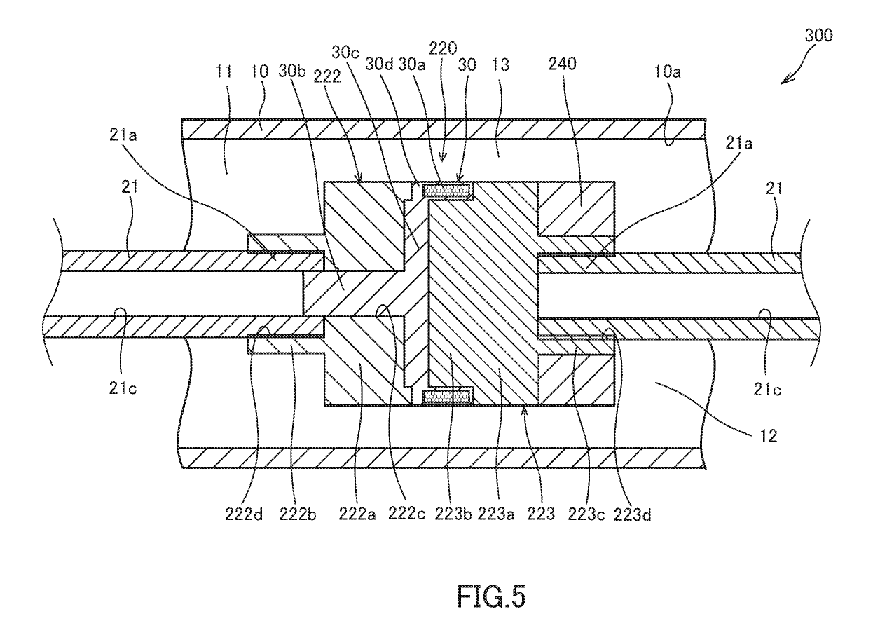

The following describes a damper 300 according to the third embodiment of the present invention with reference to FIG. 5. Hereinafter, the difference from the first embodiment described above will be mainly described. Like reference numerals designate identical configurations to the damper in the first embodiment, and therefore such configurations will not be further elaborated here.

The third embodiment differs from the first embodiment in the following points. While the damper 100 of the first embodiment is a single-rod type, the damper 300 of the third embodiment is a double-rod type. Additionally, while the damper 100 of the first embodiment guides the piston core 20 by the guiding portions 22b, the damper 300 of the third embodiment guides a piston core 220 by the piston rods 21 disposed on both sides of the piston core 220.

As illustrated in FIG. 5, the damper 300 is the double-rod type damper where the piston rods 21, which extend to the outside of the cylinder 10, are coupled to both sides of the piston core 220. The piston rod 21 is supported by a bearing (not illustrated) disposed at a cover member (not illustrated), which obstructs openings on both ends of the cylinder 10.

The piston core 220 includes a first core 222, the coil assembly 30, and a second core 223. The first core 222 is mounted to the one-end 21a of the one piston rod 21 extending to the outside of the cylinder 10. The electromagnetic coil 30a is disposed on the outer periphery of the coil assembly 30. The second core 223 sandwiches the coil assembly 30 with the first core 222. The second core 223 is mounted to the one-end 21a of the other piston rod 21. The first core 222 and the second core 223 are made of the magnetic material.

The first core 222 includes an approximately columnar-shaped main body 222a and a small-diameter portion 222b. The small-diameter portion 222b has a diameter smaller than that of the main body 222a and is formed at one-end of the main body 222a.

The first core 222 has a through-hole 222c that axially passes through a center. The through-hole 222c includes a female thread portion 222d screwed with the male screw 21d, which is formed on the one-end 21a of the piston rod 21.

The second core 223 includes a columnar-shaped main body 223a, a supporting portion 223b, and a small-diameter portion 223c. The supporting portion 223b has a diameter smaller than that of the main body 223a and is formed at one end of the main body 223a. The small-diameter portion 223c has a diameter smaller than that of the main body 223a and is formed at the other end of the main body 223a. An outer shape of the main body 223a is formed to be identical to an outer shape of the main body 222a of the first core 222.

The small-diameter portion 223c of the second core 223 includes a female thread portion 223d screwed with the male screw 21d, which is formed on the one-end 21a of the other piston rod 21.

With the damper 300, the throttle passage 13 is annularly formed between the inner peripheral surface 10a of the cylinder 10 and the outer peripheral surface of the piston core 220, specifically, between the inner peripheral surface 10a of the cylinder 10 and the outer peripheral surfaces of the first core 222, the coil assembly 30, and the second core 223.

A spacer 240 is mounted on one end surface on the second core 223 side of the piston core 220. An outer shape of the spacer 240 is formed to be identical to an outer shape of the piston core 220. Specifically, the spacer 240 is formed to have the outer shape identical to the outer shapes of the main body 222a of the first core 222 and the main body 23a of the second core 23. Furthermore, the spacer 240 is formed into an annular shape having an inner diameter with which the spacer 240 is fittable to an outer periphery of the small-diameter portion 223c of the second core 223.

Thus, mounting the spacer 240 to the one end portion of the piston core 220 allows lengthening the length of the throttle passage 13. This allows increasing the resistance generated by the throttle passage 13 even if the flow passage area of the throttle passage 13 is expanded. Furthermore, the adjustment of the axial length of the spacer 240 allows adjusting the resistance generated by the throttle passage 13.

The adjustment of the damping force by the damper 300 and the actions of the spacer 240 are similar to the first embodiment; therefore, the following omits the explanation.

The above-described third embodiment provides the following effects in addition to the effects of the first embodiment.

With the damper 300, bearings disposed on both ends of the cylinder 10 support the piston rod 21, which are mounted on both sides of the piston core 220. Accordingly, even without a guiding member at the piston core 220, the piston core 220 does not deviate. It should be noted that, the spacer 240 may be disposed on the end surface on the first core 222 side. The damper 300 may not include the above-described gas chamber (not illustrated) and free piston (not illustrated).

The following summarizes configurations, actions, and effects according to the embodiments of the present invention configured as described above.

The damper 100, 200, or 300 includes the cylinder 10 into which the magneto-rheological fluid is sealed, the piston (piston core 20, 120, or 220), the first fluid chamber 11 and the second fluid chamber 12, the throttle passage 13 or 113, the electromagnetic coil 30a, and the adjusting member (spacer 40, 140, or 240). The piston (piston core 20, 120, or 220) is made of the magnetic material and is movably disposed in the cylinder 10. The first fluid chamber 11 and the second fluid chamber 12 are partitioned by the piston (piston core 20, 120, or 220) in the cylinder 10. The throttle passage 13 or 113 is formed between the inner peripheral surface 10a of the cylinder 10 and the outer peripheral surface of the piston (piston core 20, 120, or 220). The throttle passage 13 or 113 communicates between the first fluid chamber 11 and the second fluid chamber 12. The throttle passage 13 or 113 provides the resistance to the flow of the passing magneto-rheological fluid. The electromagnetic coil 30a is disposed at the piston (piston core 20, 120, or 220) to generate the magnetic field. The magnetic field acts on the magneto-rheological fluid flowing through the throttle passage 13 or 113. The adjusting member (spacer 40, 140, or 240) is mounted to the piston (piston core 20, 120, or 220). The adjusting member (spacer 40, 140, or 240) is configured to adjust the length of the throttle passage 13 or 113.

With this configuration, the throttle passage 13 or 113 is formed between the inner peripheral surface 10a of the cylinder 10 and the outer peripheral surface of the piston (piston core 20, 120, or 220). The length of the throttle passage 13 or 113 is adjusted with the adjusting member (spacer 40, 140, or 240). Because this allows appropriately imparting the resistance to the magneto-rheological fluid, it is possible to obtain the desired damping force.

With the damper 100 or 300, the adjusting member (spacer 40 or 240) has the outer shape approximately identical to the outer shape of the piston (piston core 20 or 220).

With this configuration, the adjusting member (spacer 40 or 240) has the outer shape approximately identical to the outer shape of the piston (piston core 20 or 220). This does not disturb the flow of the magneto-rheological fluid when the magneto-rheological fluid passes through a peripheral area of the adjusting member (spacer 40 or 240). This allows preventing the deviation of the piston (piston core 20 or 220) when the piston (piston core 20 or 220) moves inside the cylinder 10.

With the damper 100, 200, or 300, the adjusting member (spacer 40, 140, or 240) and the piston (piston core 20, 120, or 220) are configured to fit to one another.

With this configuration, the adjusting member (spacer 40, 140, or 240) and the piston (piston core 20, 120, or 220) are configured to fit to one another. This does not displace the axis centers of the adjusting member (spacer 40, 140, or 240) and the piston (piston core 20, 120, or 220). This allows configuring the throttle passage 13 or 113 as the flow passage with uniform degree of opening.

With the damper 100, 200, or 300, the adjusting member (spacer 40, 140, or 240) is mounted to the one end portion of the piston (piston core 20, 120, or 220).

With the damper 100, 200, or 300, the piston (piston core 20, 120, or 220 is constituted of the plurality of members. The adjusting member (spacer 340) is disposed between the plurality of members constituting the piston (piston core 20, 120, or 220).

With the damper 100, 200, or 300, the adjusting member (spacer 40, 140, or 240) is made of the magnetic material.

Embodiments of this invention were described above, but the above embodiments are merely examples of applications of this invention, and the technical scope of this invention is not limited to the specific constitutions of the above embodiments.

It is possible to provide a spacer in the first and the second embodiments on the piston rod 21 side (the first core 22 or 122 side) in the similar manner as the spacer 240 in the third embodiment.

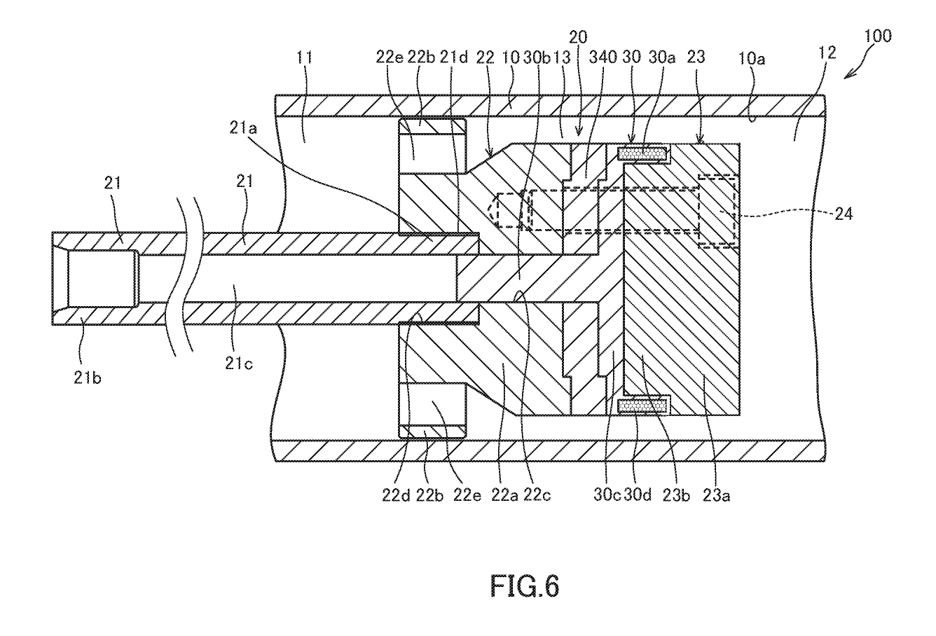

The spacers 40 and 240 are disposed at the one end portions of the piston cores 20 and 220 in the first and the third embodiments respectively. However, like a modification illustrated in FIG. 6, a spacer 340 may be disposed between the first core 22 and the coil assembly 30. In this case, the spacer 340 is made of the magnetic material. It should be noted that, the spacer 340 may be disposed between the coil assembly 30 and the second core 23.

From the first embodiment through the third embodiment, the second core 23 or 223 supports the coil assembly 30. However, the first core 22, 122, or 222 may support the coil assembly 30.

This application claims priority based on Japanese Patent Application No. 2015-226548 filed with the Japan Patent Office on Nov. 19, 2015, the entire contents of which are incorporated into this specification.

1. A magneto-rheological fluid damper that employs magneto-rheological fluid as working fluid, the magneto-rheological fluid changing apparent viscosity according to a strength of a magnetic field, the magneto-rheological fluid damper comprising:
a cylinder into which the magneto-rheological fluid is sealed;
a piston made of a magnetic material, the piston being movably disposed in the cylinder;
a first fluid chamber and a second fluid chamber partitioned by the piston in the cylinder;
a throttle passage formed between an inner peripheral surface of the cylinder and an outer peripheral surface of the piston, the throttle passage communicating between the first fluid chamber and the second fluid chamber, the throttle passage providing a resistance to a flow of the passing magneto-rheological fluid;
an electromagnetic coil disposed at the piston, the electromagnetic coil being configured to generate the magnetic field, the magnetic field acting on the magneto-rheological fluid flowing through the throttle passage; and
the adjusting member mounted to the piston, the adjusting member being configured to adjust a length of the throttle passage.

2. The magneto-rheological fluid damper according to claim 1, wherein the adjusting member has an outer shape approximately identical to an outer shape of the piston.

3. The magneto-rheological fluid damper according to claim 1, wherein the adjusting member and the piston are configured to fit to one another.

4. The magneto-rheological fluid damper according to claim 1, wherein the adjusting member is mounted to one end portion of the piston.

5. The magneto-rheological fluid damper according to claim 1, wherein:
the piston is constituted of a plurality of members, and
the adjusting member is disposed between the plurality of members constituting the piston.

6. The magneto-rheological fluid damper according to claim 5, wherein
the adjusting member is made of a magnetic material.
